(19) United States
(12) Patent Application Publication
(10) Pub. No.: US 2013/0323584 A1
(43) Pub. Date: Dec. 5, 2013

(54) METHOD FOR PRODUCING AN ELECTRODE/SEPARATOR STACK INCLUDING FILLING WITH AN ELECTROLYTE FOR USE IN AN ELECTROCHEMICAL ENERGY STORAGE CELL

(71) Applicants: Tim Schaefer, Harztor (DE); Dieter Olpp, Munchen (DE)

(72) Inventors: Tim Schaefer, Harztor (DE); Dieter Olpp, Munchen (DE)

(73) Assignee: LI-TEC BATTERY GMBH, Kamenz (DE)

(21) Appl. No.: 13/990,285

(22) PCT Filed: Nov. 23, 2011
(86) PCT No.: PCT/EP11/05938

§ 371 Date: Aug. 12, 2013

(30) Foreign Application Priority Data
Nov. 29, 2010 (DE) 10 2010 052 843.9

(51) Int. Cl. H01M 2/36

(52) U.S. Cl. CPC H01M 2/36
USPC 429/209; 429/247; 429/246; 29/623.1

(57) ABSTRACT

A method for producing an electrochemical energy storage cell, which has a stack 1 of sheets 2, in particular electrode and/or separator sheets 2, and a liquid electrolyte 4, has the following steps: producing interspaces between a large number of adjacent sheets 2 in the stack 1 (step S1), bringing the stack 1 into contact with the electrolyte 4 (step S2), removing the interspaces produced in step S1 between the large number of adjacent sheets 2 in the stack 1 (step S3). As a result, the electrolyte 4 can be distributed quickly and uniformly over the surfaces of the large number of sheets 2. In a particularly preferred embodiment of the method, step S1 has the following substeps: fixing a large number of sheets 2 in the stack 1 relative to one another at at least one point (step S1.1, optional), bending the stack 1, wherein the sheets 2 in the stack 1 are at least partially movable with respect to one another (step S1.2), fixing a large number of sheets 2 in the bent stack 1 relative to one another, with the result that the large number of sheets 2 are fixed in each case relative to one another at at least two points (step S1.3), returning the bent stack 1 to a shape which approximately corresponds to the initial shape of the stack 1, whilst maintaining the fixings from step S1.1 and/or S1.3 (step S1.4).

The content of priority application DE 10 2010 052 843.9 is herewith incorporated in its entirety in the present application by reference.

The present invention relates to a method for producing an electrochemical energy storage cell which has a stack of sheets, particularly electrode and/or separator sheets, and a liquid electrolyte.

The term electrochemical energy storage cells refers to the smallest units of devices for the chemical storage of electrical energy, particularly non-rechargeable energy storage cells, also known as primary cells, such as alkali batteries, and rechargeable energy storage cells, also known as secondary cells or accumulator cells, such as nickel metal hydride or lithium-ion battery cells.

An energy storage cell of such kind generally comprises an electrode arrangement consisting of a plurality of two-dimensional electrodes or electrode layers that are positioned alternatingly one on top of the other, wherein positive electrodes (cathodes) and negative electrodes (anodes) take turns in this arrangement. A separator or separator layer is interposed between two adjacent electrodes or electrode layers and serves to prevent electrical contact between two electrodes with different polarities, and thus also a short circuit. The electrode arrangement is filled with a preferably liquid electrolyte to ensure electrical conductivity inside the energy storage cell. Depending on the constitution of the electrode and separator surfaces—smooth or porous for example—these surfaces should for example only be wetted, or even be impregnated by the electrolyte. However, the electrolyte should be spread so as to cover the surfaces of the electrodes and separators as completely as possible, in order to assure good conductivity and thus also high capacitance of the electrochemical energy storage cell.

In the case of a lithium-ion cell, the electrodes may be made for example from aluminium or copper foil coated with graphite, and the separator may be made from a ceramic material deposited on a plastic substrate. The separator may for example consist of an organic material that contains lithium ions.

An electrode arrangement of this kind is produced for example by winding up a series of electrode and separator strips placed one on top of the other or by alternately layering individual electrode and separator sheets. In the case of a layered electrode arrangement all anode sheets or all cathode sheets, resp., are connected to each other in electrically conductive manner by metal conductors for discharging the current.

In the present patent application, only electrode arrangements of the last kind described that are obtained by layering sheets, particularly electrode and separator sheets, are considered. Such an arrangement of sheets layered on top of each other, in which the individual sheets form essentially flat and essentially parallel surfaces, is referred to in the following as a stack. The term “sheet” is understood to be a two-dimensional object, preferably a thin two-dimensional object, i. e. a two-dimensional object the dimensions of which in a direction perpendicular to a its surface are significantly smaller than the diameter of the largest circle that lies completely inside the surface. The individual sheets in this case are preferably rectangular and are preferably also of the same size. For this reason, the present invention is described with respect to rectangular sheets of the same size. It should be noted, however, that the sheets may also be of any other shape and size.

When producing energy storage cell with electrode arrangements of such kind, the problem arises of filling the electrode arrangement with the liquid electrolyte in such manner that the electrolyte comes into full contact with the surfaces of all electrode and separator sheets. This is rendered more difficult by the fact that the individual sheets are already lying closely packed one on top of the other in the production process immediately before the filling step, and it is therefore difficult for the electrolyte to infiltrate between the sheets from the outside and spread evenly and completely to come into contact with the entire surface of each individual sheet. There is also a risk that the sheets in the outer area, which are the first to come into contact with the electrolyte, may become entirely saturated and—depending on the material—may swell up so that the electrolyte is unable to penetrate further into the inner areas of the sheet surfaces.

It is known to fill an electrode arrangement of this kind, comprising a stack of electrode and separator sheets, in such manner that the stack is positioned upright and the electrolyte is added to a long or narrow side of the stack, for example by instilling or injecting. The electrolyte is then drawn downwards into the stack by gravity or capillary attraction and spreads there more or less quickly and evenly over the surfaces of the individual sheets. The spreading process is supported by a sufficiently long soaking time, which may be in the order of minutes, hours or even days, in order to guarantee even distribution of the electrolyte over the sheets. This soaking time causes substantial delays in the production process.

The object of the present invention is therefore to develop a method with which the electrolyte may be brought into contact with the surfaces of the electrode and separator sheets simply, quickly and reliably.

This object is solved by a method for producing an electrochemical energy storage cell according to claim 1, wherein advantageous improvements and embodiments of the method are described in the subclaims.

The method according to the invention is based on the idea that the liquid electrolyte is able to pass between the sheets of the stack and come into contact with the surfaces thereof more easily if a small interspace is present between each of the adjacent sheets in the stack. However, since the sheets in the stack are arranged closely together on top of each other, a method is needed to “fan out” the sheets in the stack, thereby bringing them into a “lamella-like” structure. Then, the stack may be positioned upright in such manner that the fanned-out side is facing upward and the electrolyte may easily be introduced into individual spaces between the sheets from above. The electrolyte will then spread evenly over all surfaces of all sheets in the stack, since it is able to reach them directly and in an unobstructed way.

The method according to claim 1 therefore comprises the following steps, wherein the steps may also be carried out repeatedly and/or in an order other than the order indicated:
Interspaces are created between a plurality of adjacent sheets in the stack.
The stack is brought into contact with the electrolyte.
The interspaces created between the plurality of adjacent sheets in the stack are removed again.

In this context, the width of an interspace is preferably at least equal to the thickness of a sheet, more preferably at least double the thickness of a sheet.

Here too, a certain “soaking time” may be provided between the point of time when the stack is brought into contact with the electrolyte and the point of time when the interspaces are removed, wherein the duration of the necessary soaking time will be considerably shorter than if there were no interspaces between the sheets.

In a particularly preferred embodiment of the method according to the invention, the step of creating interspaces between a plurality of adjacent sheets in the stack may comprise at least the following substeps in the following sequence:
A plurality of sheets in the stack are fixed relative to each other at at least one point. In this context, “fixing” is understood to mean that a relative movability of the sheets toward each other at this point is prevented, preferably by clamping and/or by a block. This step is optional at this point in the method (see below).
The stack is bent, the sheets in the stack being at least partially movable toward each other. Bending is effected by the application of suitable forces from the outside. In this context, the shape of the bent stack may be the result of the material properties of the sheets themselves, particularly by the bending stiffness thereof, by the forces applied from the outside, or also by a shaping body, against which the stack is pressed during bending.

The angle by which the stack is bent (i. e.—if bending along a circle—the wrap angle of the bent stack about this circle), is preferably chosen to be as large as possible. It is preferably at least 90 degrees, more preferably at least 180 degrees.

Since the stack, due to the thickness of the individual sheets, also has a certain total thickness, the sheets on the inner edge of the stack—closest to the virtual center point of the bending—are bent more than the sheets on the outer edge of the stack—farthest from the virtual center point of the bending. The side edges of the individual sheets that extend perpendicularly to the plane in which the bending takes place, and which are therefore not bent themselves, are thereby slightly shifted toward each other. This movement takes place on a side of the sheets on which the sheets are not fixed with respect to each other, or, if the above fixing step has not been carried out, possibly on two opposite sides of the sheets.
The plurality of sheets in the bent stack are fixed relative to each other. If the sheets have already been fixed relative to each other in the first step, then in this step it is only necessary to fix them at at least one further point, otherwise at at least two further points. In all cases, all sheets are now fixed relative to each other at at least two points.
The bent stack is restored to a shape approximately corresponding to its original shape, retaining the fixations effected. The restoration of the stack is preferably effected by removing the external forces that caused the bending, whereby the stack approximately returns to its original shape by the relaxation of the individual bent sheets. However, the stack may also be restored by actively introducing forces acting in the opposite direction to the bending forces.
However, the shifting of the side edges of the plurality of sheets relative to each other caused by bending the stack and the fixations as described above means that the sheets are unable to completely return to their original position, in which they were parallel to each other. Instead, between each pair of adjacent sheets a slightly different curvature is formed on these two sheets to compensate for the mutual shift between them, thereby forming a small gap between them, which grows narrower towards the fixing points, and—assuming a symmetrical form of the gap—is widest in the middle. The stack remains mechanically stable due to the fixation.

After these steps have been carried out, the electrolyte may be brought into contact with the stack. In a particularly preferred embodiment of the invention, this is effected by pouring in the electrolyte. The stack is preferably aligned for this purpose in such a way that one side of the stack on which the gaps have been formed is facing upward. The electrolyte is then preferably poured in in a stream of liquid directed onto the stack from above, for example by instilling or injecting.

Alternatively, it is also possible to immerse the entire stack in an electrolyte bath or conversely to flood the stack with electrolyte by placing the stack in a vessel and pouring the electrolyte into said vessel until the stack is entirely covered by the electrolyte. In both methods, the stack may be held from above by the conductors (if these are already present in this production step), which should not come into contact with the electrolyte anyway.

It is also possible to centrifuge the stack while and/or after bringing the stack into contact with the electrolyte in step S2, wherein centrifuging is understood to mean rapid rotation about an axis of rotation. In this context, the centrifuging is preferably carried out about one or (consecutively) several axes of symmetry of the stack, in order to avoid an imbalance of the stack during centrifuging. If centrifuging is carried out while the stack is being brought into contact with the electrolyte, the electrolyte is preferably poured into the stack from above along the axis of rotation of the centrifuging procedure. Centrifuging ensures that the spreading of the electrolyte in the stack is further improved due to the centrifugal forces that are generated.

The last step in the method according to the invention, the removal of the interspaces between the plurality of adjacent sheets in the stack, is effected in a particularly preferred embodiment by releasing the fixations effected. If the sheets have sufficient bending stiffness, they assume their original shape as flat surfaces again automatically. Likewise, the stack also automatically assumes its original shape consisting of sheets lying closely on top of one another, wherein the electrolyte is spread evenly over the surfaces of the sheets. Alternatively, the original shape of the stack may also be restored by applying gentle pressure from the outside to the two outermost sheets of the stack after the fixations have been released.

After the interspaces have been removed, a force may also be applied to the stack from the outside so that inside the stack the electrolyte is spread even better. This force is preferably a pressing, brushing or rolling motion. Depending on the nature of the motion, it is preferably exerted by one or more plates compressing the stack from one or both sides from the outside, by one or more scraper blades pressing against one or both sides of the stack from the outside by brushing over the surface of the stack, or by one or more rollers pressing against one or both sides of the stack from the outside by rolling over the surface of the stack, resp. The brushing or rolling may also take place in multiple directions, in order to spread the electrolyte well in all directions in the stack.

In a preferred embodiment of the invention, at least two sequences of steps of fixing a plurality of sheets, bending the stack and restoring the bent stack are carried out one after the other. Hereby, the stack is bent in opposite directions in the two consecutive step sequences. The advantage of this is that the sheets that have the largest curvature after the first bending and restoration of the stack, and between which the smallest gaps are created, have the smallest curvature and the largest gaps created between them after the stack has been bent in the opposite direction, and vice versa. In this way, after at least one such sequence of steps the gap between each two sheets is large enough to allow the electrolyte to spread there easily. It is also possible to pour a portion of the electrolyte into the stack after the first sequence of steps has been carried out, and a further or the remaining portion of the electrolyte into the stack after the second sequence of steps has been carried out.

In a further preferred embodiment of the invention, at least two sequences of steps of fixing a plurality of sheets, bending the stack and restoring the bent stack are carried out one after the other. Hereby, the plurality of sheets are at least partially fixed at different points of the stack, preferably sectionwise from top to bottom or from bottom to top along two opposite edges of the stack, wherein the stack is positioned upright.

Also when fixing the plurality of sheets in such a way only partially and preferably sectionwise, the stack may still be bent in almost the same way, and the desired interspaces between the sheets may thus still be created in the same way. At the same time, however, it is ensured that no point on the surface of the sheets is covered or pressed against adjacent sheets by a fixing device, a clamping rail for example, throughout the entire process. Such a point would possibly not be accessible by the electrolyte until after the fixing was released. Therefore, this embodiment assures even better spreading of the electrolyte in the stack.

In a preferred embodiment of the invention, the plurality of sheets in the bent stack are fixed relative to each other in the area of two opposite edges of the stack, preferably on the two long sides or the two narrow sides of the stack. In this way, the stack may easily be bent after or before the fixation, resp., in a direction extending perpendicularly to the direction of the fixation. In this way, all steps of the method are carried out in a direction parallel to a side edge of the stack, which can mechanically be realized particularly easily.

In a further preferred embodiment of the invention, the plurality of sheets in the bent stack are fixed relative to each other in the area of an edge of the stack and in the area of at least one corner of the stack that is not located on this edge. Fixing the stack at a corner may be advantageous if two opposite sides of the stack are not available for fixing, for example because the electrolyte is to be poured in on one of these sides, and the other pair of opposite sides of the stack is not accessible due to space limitations during production. In this embodiment, however, it is also possible to pour the electrolyte in from different sides, for example from a long side and from one or two narrow sides, which ensures an even better reachability of the complete surfaces of the sheets in the stack.

The fixation of a plurality of sheets in the stack relative to each other is preferably effected by clamping the plurality of sheets using clamping elements.

In this context, clamping means the application of an external pressure onto the stack from both sides at the desired points , the pressure being dimensioned such that the sheets are substantially unable to move relative to each other, but are not deformed or damaged either. Suitable clamping elements for this are for instance clamping rails or spot-shaped clamps, which are biased by spring pressure, for example.

However, fixing may also be carried out by positioning the plurality of sheets in the bent stack against a blocking element, for example a blocking profile. Here, the blocking element is designed such that when the stack is restored the sheets are prevented from returning fully to their original position, because at least one side edge thereof abuts on the stop element. The blocking element is preferably in the shape of a V-shaped profile.

In a further preferred embodiment of the invention, the stack is entirely or partially inside a cover throughout all or almost all steps of the method. This helps to ensure that after the electrolyte has been brought into contact with the stack, it does not leak from the stack, and thus renders temporary sealing measures unnecessary. This in turn simplifies the course of action of the method significantly. Of course, a requirement for this configuration is that the cover must be sufficiently flexible to enable the individual process steps to be carried out, particularly bending the stack and fixing the sheets.

It is particularly preferred if the cover is the outer cover of the electrochemical energy storage cell. Such energy storage cells with flexible outer cover, also called pouch or coffee bag cells, are known and widely used. The use of the outer cover of the energy storage cell as a cover for the purpose of the embodiment described enables the method to be simplified still further, since the stack is inserted in its final outer cover before the method is carried out, and remains inside this outer cover during and after the method is carried out.

Alternatively, the cover may also be an additional, flexible cover, for example in the form of a thin, elastic foil bag, which later forms an additional layer around the stack inside the (possibly inflexible) outer cover in the final energy storage cell.

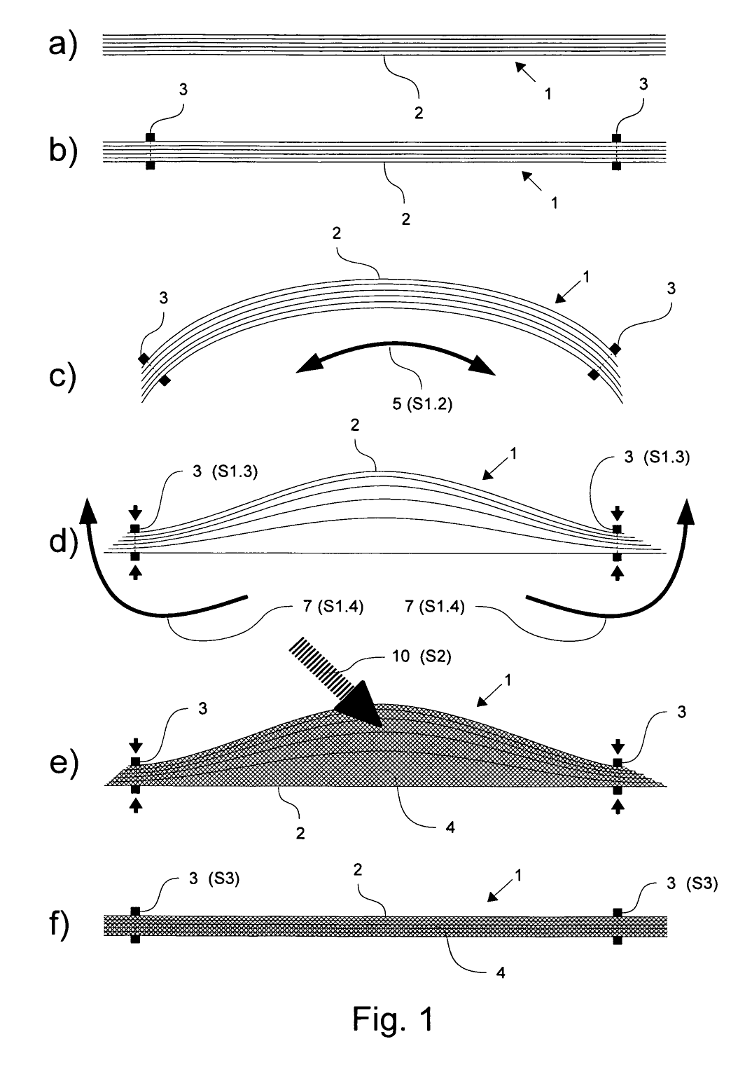

The method according to the invention will now be explained on the basis of several embodiments and with reference to the partially diagrammatic FIGS. 1 to 4, where

FIG. 1 shows the method steps in a first embodiment, wherein the stack is fixed at two opposite sides after bending;

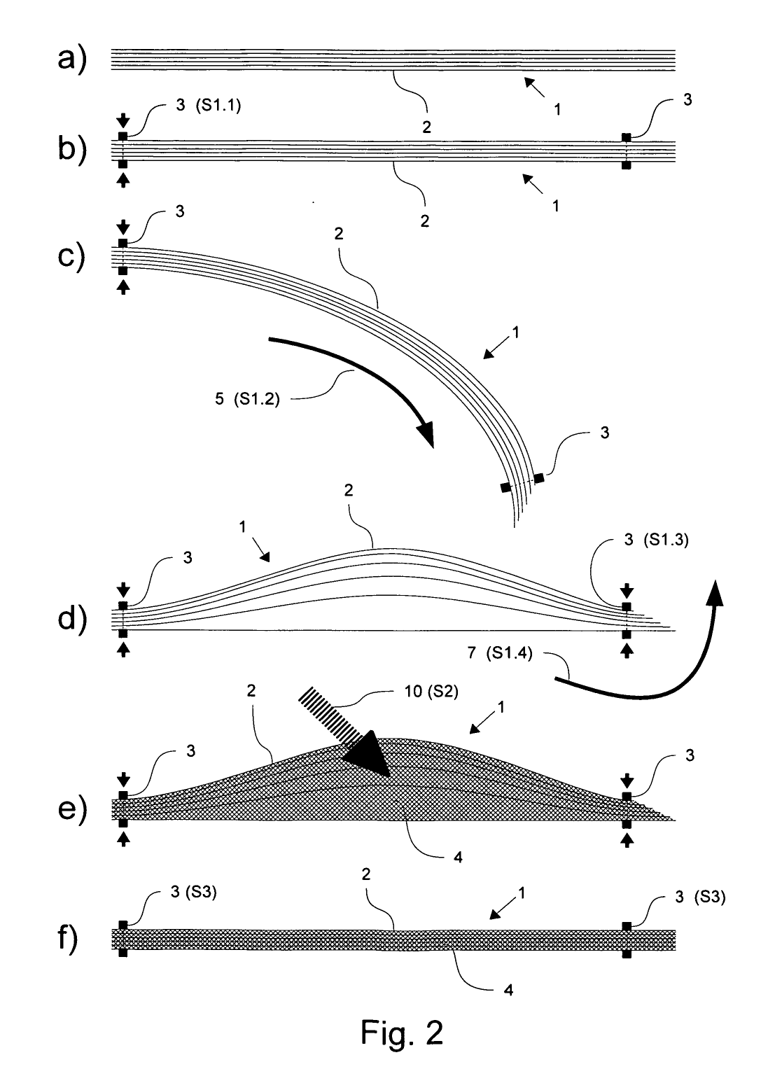

FIG. 2 shows the method steps in a second embodiment, wherein the stack is fixed at a first side before bending and at a side opposite the first side after bending;

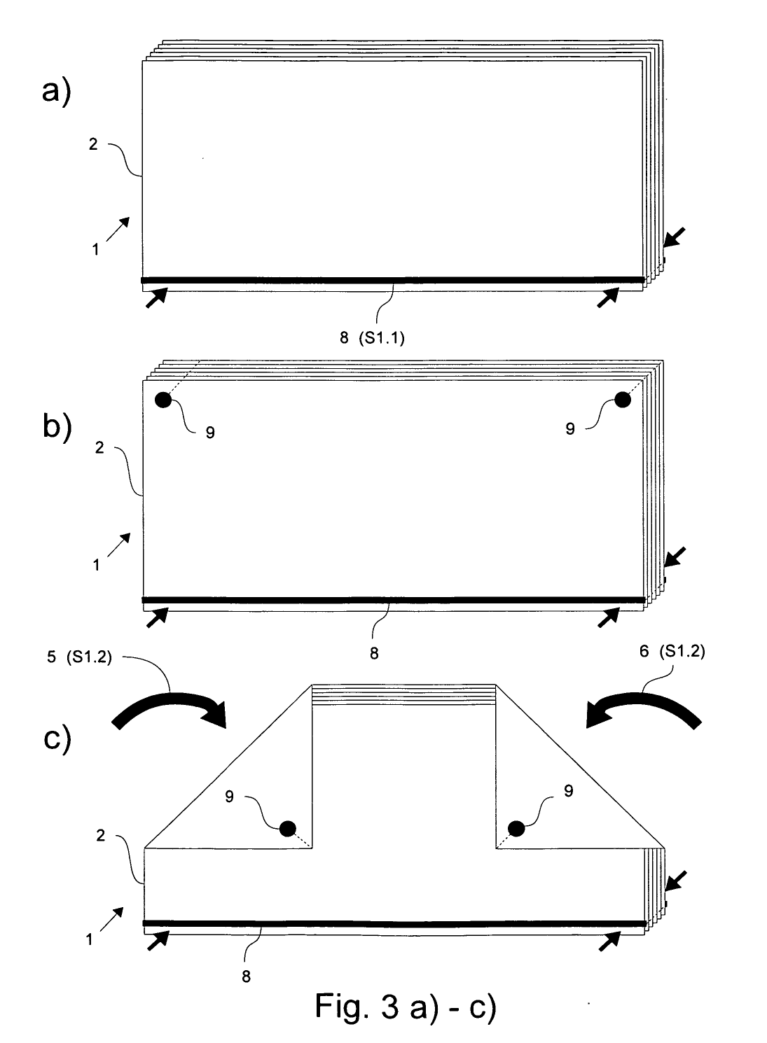

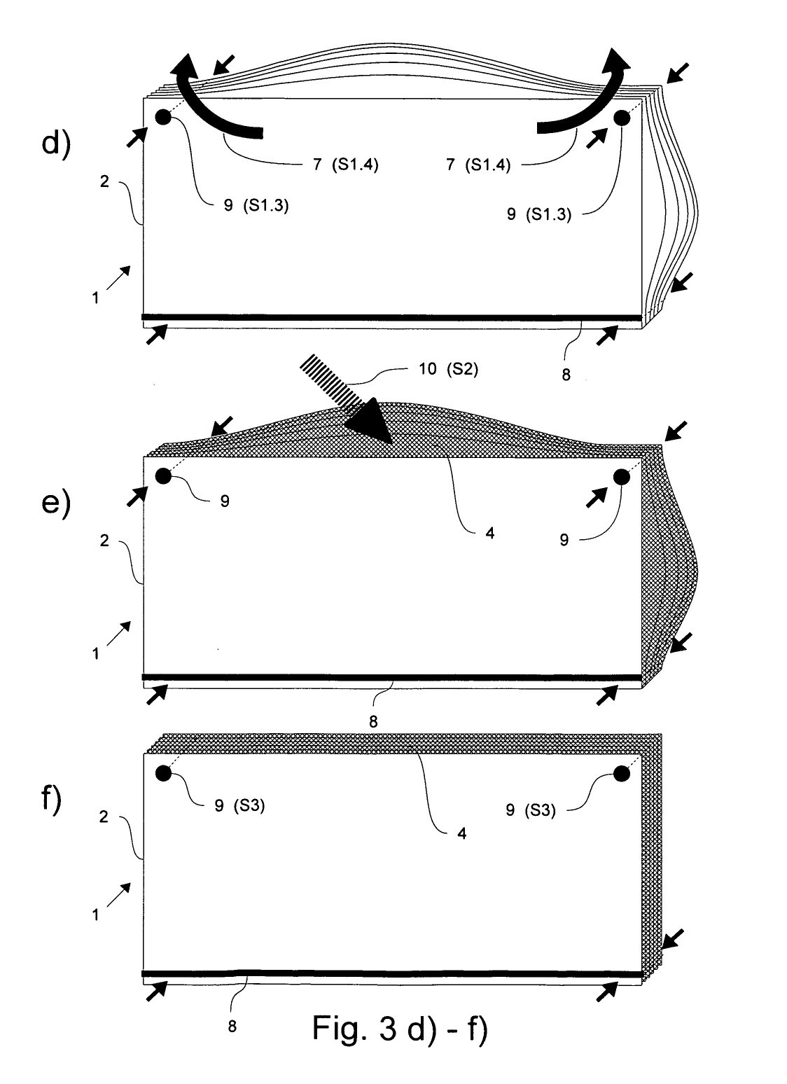

FIG. 3 shows the method steps in a third embodiment, wherein the stack is fixed at one side and two corners.

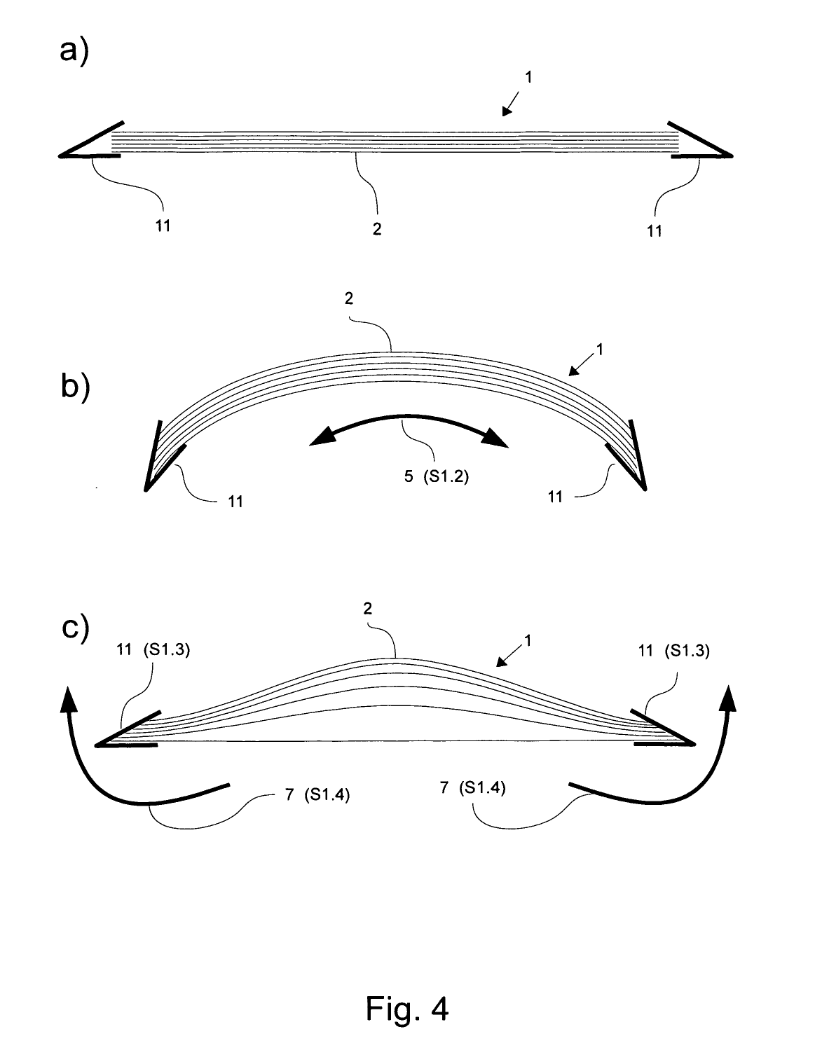

FIG. 4 shows a variation of the first embodiment, wherein two opposite side edges of the stack are fixed by two blocking profiles.

FIG. 1a) is a diagrammatic representation of cross section of a stack 1 comprising six electrode and separator sheets 2, wherein the gaps between the individual sheets 2 only serve to show sheets 2 more clearly; in reality, sheets 2 are lying closely on top of each other.

In FIG. 1b), stack 1 is clamped loosely at two points close to two opposite side edges by two edge clamps 3, so that the sheets are able to move relative to each other at both clamping points. Edge clamps 3 are each indicated in the drawing by two black squares (clamping rails) joined by a dashed line. Each clamping is designed to take effect along the entire side edge of stack 1.

The optional step of fixing sheets 2 before stack 1 is bent (step S1.1) is not carried out in this embodiment.

In FIG. 1c), stack 1 is bent along an approximately circular path in a bending direction 5 (step S1.2). Thereby, sheets 2 shift relative to each other between edge clamps 3.

In FIG. 1d), the clamping of stack 1 is fixed at each of the two edge clamps 3 by bracing the two clamping rails against each other, indicated in each case by two arrows pointing inwards (step S1.3). Sheets 2 are now no longer able to move relative to each other between the fixed edge clamps 3. After this fixation, the stack is restored in direction 7 to its original position—as far as possible—by removing the bending forces again (step S1.4). This causes the creation of the desired interspaces between sheets 2, which spaces become narrower from the inside towards the outside (viewed from the center point of the bending radius). Due to the bending stiffness of electrode and separator sheets 2, sheets 2 and thus also the interspaces between the sheets retain their shape in this position of stack 1 as long as edge clamps 3 are not released.

In FIG. 1e), electrolyte 4 (indicated by the hatching in the drawing) is poured from above in direction 10 into the interspaces between sheets 2 in stack 1 (Step S2). Because of the interspaces, the electrolyte is then able to spread out easily there, with the possible exception of the areas of fixed edge clamps 3.

In FIG. 1f), the stack fixation by edge clamps 3 is removed again, optionally after a short soaking time. In this way, the stack ultimately resumes its original shape of flat, parallel sheets 2, and the interspaces are removed (step S3). Electrolyte 4 may now also spread in the area of edge clamps 3 between sheets 2.

Bending stack 1, fixing and releasing edge clamps 3 and the restoration of stack 1 is carried out by suitable mechanical means (not shown) and may be fully automated in the production process.

The method shown in FIG. 2 differs from the one shown in FIG. 1 in that stack 1 is fixed by an edge clamp 3 on the left edge of stack 2 before it is bent (step S1.1), while stack 1 is only clamped loosely on the right edge by edge clamp 3 before bending (see FIG. 2b).

In FIG. 2c), stack 1 is bent in bending direction 5, wherein the fixing by edge clamp 3 is preserved (Step S1.2). In the embodiment shown, fixed edge clamp 3 also remains immovable during bending; however this side of the stack may also be moved—as in FIG. 1c)—when stack 1 is bent. However, sheets 2 are still able to move relative to each other in the area of edge clamp 3 on the right edge of stack 1 during bending.

In FIG. 2d), edge clamp 3 is also fixed on the right edge of stack 1 when stack 1 is in the bent state (step S1.3).

Then, the right side of stack 1 is restored almost to its original position along direction 7 (step S1.4).

Similarly to FIGS. 1e) and 1f), FIGS. 2e) and 2f) represent the filling in of electrolyte 4 (step S2) and the relaxation of stack 1 filled with electrolyte to its original position and thus the removal of the interspaces (step S3.

FIG. 3a) is a perspective view of a stack 1 which is already fixed at its bottom long side by a clamping rail 8 (corresponds to step S1.1). This is because the conductor tabs of electrode sheets 2 (not shown) are located at this long side of stack 1, which conductor tabs are already connected to a package and cannot be released anymore in this production step. In fact, in this case the method shown in FIG. 2 could be used similarly, wherein stack 1 is clamped at its long sides and electrolyte 4 is filled in at a narrow side. However, this may be unfavourable due to the short length of the narrow sides of stack 1 relative to the length of the long sides, because electrolyte 4 would then have to travel a relatively long distance along the long side of stack 1 to reach the lowest point of stack 1.

In this case, therefore, the following modified method is used:

As shown in FIG. 3b), stack 1 is initially substantially punctiformly clamped loosely in the area of the two corners opposite clamping rail 8 using point clamps 9.

In FIG. 3c), stack 1 is then bent diagonally forwards at these two corners along two bending directions 5 and 6 (step S1.2).

Then, as shown in FIG. 3d), point clamps 9 are fixed (step S1.3), which is again represented by arrows pointing inwards, and the stack is restored—as far as possible—in direction 7 to its original position again (step S1.4). Hereby, sheets 2 are fanned out both at the upper long side and at the two narrow sides, wherein the width of an interspace between two sheets 2 in stack 1 becomes narrower from the top down (in the direction of clamping rail 8).

Here too, as shown in FIG. 3e), electrolyte 5 is poured into stack 1 in a pouring direction 10 from above (step S2) and is able to spread downwards before stack 1 in FIG. 3f) ultimately resumes its original form due to the release of fixed point clamps 9 and the interspaces are removed (step S3).

FIG. 4 shows a variation of the method shown in FIG. 1, wherein subfigures 4a), 4b) and 4c) correspond to the steps of subfigures 1b), 1c) and 1d).

In FIG. 4, the sheets 2 in stack 1 are not clamped, but the opposite sides thereof are positioned against two blocking profiles 11, each of which has a cross section in the form of an acute angle (see FIG. 4a).

In FIG. 4b), stack 1 is bent in a bending direction 5, wherein the side edges of sheets 2 shift towards each other and slide into the interior of the respective blocking profile 11 (step S1.2).

In FIG. 4c), stack 1 is restored in direction 7 (step S1.4), wherein the side edges of sheets 2 are held in place in their offset positions relative to each other by blocking profiles 11 (step S1.3), and again the desired interspaces are formed between the individual sheets 2 by this offset. In order to mechanically support the retention of sheets 2 in place at the inner sides of blocking profiles 11 and to prevent sheets 2 from slipping off at the inner sides of blocking profiles 11, the inner sides of blocking profiles 11 may also be furnished with a rough, slip-proof or flaky surface.

In this way, it is possible to fix sheets 2 relative to each other in a mechanically very simple way and without the risk of damaging sheets 2 by clampings.

### REFERENCE SIGN LIST

1 Stack

2 Sheet

3 Edge clamp

4 Electrolyte

5, 6 Bending directions

6 Return direction

8 Clamping rail

9 Point clamp

10 Pouring direction for electrolyte

11 Blocking profile

1-14. (canceled)

15. A method for producing an electrochemical energy storage cell, which has a stack of sheets, particularly electrode and/or separator sheets, and a liquid electrolyte, wherein the method comprises at least the following steps, which may be carried out repeatedly and/or in an order other than the order indicated:
creating interspaces between a plurality of adjacent sheets in the stack (step S1),
bringing the stack into contact with the electrolyte (step S2), and
removing the interspaces created in step S1 between the plurality of adjacent sheets in the stack (step S3).

16. The method for producing an electrochemical energy storage cell according to claim 1, wherein the step of creating interspaces between a plurality of adjacent sheets in the stack comprises at least the following substeps in the following sequence,
bending the stack, wherein the sheets in the stack are at least partially movable toward each other (step S1.2),
after the bending the stack, fixing a plurality of sheets in the bent stack relative to each other, so that the plurality of sheets are fixed relative to each other at at least two points (step S1.3), and
after the fixing a plurality of sheets, restoring the bent stack to a shape corresponding to the original shape of the stack while retaining fixed positions corresponding to step S1.1 (step S1.4).

17. The method according to claim 16, wherein the step of creating interspaces between a plurality of adjacent sheets in the stack further comprises, prior to bending the stack, fixing a plurality of sheets in the stack relative to each other at at least one point (step S1.1).

18. The method according to claim 15, wherein the bringing the stack into contact with the electrolyte in is effected by at least one of (a) pouring or injecting the electrolyte into the stack, (b) immersing the stack in the electrolyte, and (c) flooding the stack with the electrolyte.

19. The method according to claim 15, further comprising centrifuging the stack during and/or after the operation of bringing the stack into contact with the electrolyte in step S2.

20. The method according to claim 15, further comprising, after the removal of the interspaces formed in step S1, applying a force to the stack from the outside.

21. The method according to claim 20, wherein the force applied to the stack from the outside is applied in the form of a pressing, brushing, or rolling motion.

22. The method according to claim 16, wherein the removal of the interspaces formed in step S1 between the plurality of adjacent sheets in the stack in step S3 is effected by releasing the fixations effected in step S1.3.

23. The method according to claim 16, wherein at least two sequences of steps of fixing a plurality of sheets (S1.3), bending the stack (step S1.2) and restoring the bent stack (step S1.4) are carried out one after the other, wherein the stack is bent in respectively opposite directions in step S1.2.

24. The method according to claim 16, wherein at least two sequences of steps of fixing a plurality of sheets (step S1.3), bending the stack (step S1.2) and restoring the bent stack (step S1.4) are carried out one after the other, and wherein the fixing of a plurality of sheets is carried out in step S1.3 at least partially at different points of the stack.

25. The method according to claim 16, wherein the plurality of sheets in the bent stack are fixed relative to each other in step S1.3in the area of two opposite edges of the stack.

26. The method according to claim 16, wherein the plurality of sheets in the bent stack are fixed relative to each other in step S1.3 in the area of an edge of the stack and in the area of at least one corner of the stack not located on this edge.

27. The method according to claim 16, wherein the fixing of a plurality of sheets in the stack relative to each other is effected in step S1.3 by means of clamping the plurality of sheets with the aid of clamping elements and/or by positioning the plurality of sheets against a blocking element.

28. The method according to claim 15, wherein the stack is partially or completely enclosed in a cover throughout all or nearly all of the steps of the method.

29. The method according to claim 28, wherein the cover forms the outer cover of the electrochemical energy storage cell.

30. An electrochemical energy storage cell produced by a method according to claim 15.
